(19) United States
(12) Patent Application Publication
(10) Pub. No.: US 2025/0381855 A1
(43) Pub. Date: Dec. 18, 2025

(54) ELECTRIC MOTOR VEHICLE

(71) Applicant: TOYOTA JIDOSHA KABUSHIKI KAISHA, Aichi-ken (JP)

(72) Inventor: Eiji YOSHIDA, Seto-shi (JP)

(21) Appl. No.: 19/230,083

(22) Filed: Jun. 6, 2025

(30) Foreign Application Priority Data
Jun. 17, 2024 (JP) 2024-097480

(51) Int. Cl. B60L 50/64

(52) U.S. Cl. CPC B60L 50/64

(57) ABSTRACT

An electric motor vehicle includes a battery pack including a casing containing cells and mounted under a floor of the vehicle, a first external reinforcement attached to an outer face of a bottom plate of the casing, and a share panel disposed under the first external reinforcement to cover the bottom plate of the casing. The first external reinforcement is disposed to overlap with the cells in a top view. The share panel is attached to a first lower face of the first external reinforcement.

### CROSS REFERENCE TO RELATED APPLICATION

This application claims priority to Japanese Patent Application No. 2024-97480 filed on Jun. 17, 2024, which is incorporated herein by reference in its entirety including the specification, claims, drawings, and abstract.

### TECHNICAL FIELD

The present disclosure relates to a structure of an electric motor vehicle including a battery pack mounted under a floor of the vehicle.

### BACKGROUND

JP 2023-46945 A discloses the structure of a share panel that covers the lower face of a battery pack mounted under the floor. The structure disclosed in JP 2023-46945 A includes a cross member disposed between cells stored within a casing, and a lower cross member attached to a lower end of the cross member, and a share panel is fastened to the lower face of the lower cross member.

WO 2013/073464 discloses a structure in which a casing of a battery pack has, on its upper plate, a groove extending along the vehicle width, and a cover plate is attached to the groove to cover a bottom plate of the casing and the lower face of the battery pack. In this structure, the groove is disposed between cells stored within the casing.

### SUMMARY

An increase in the battery capacity has been demanded in electric motor vehicles. This further demands an increase in the capacity within a casing for mounting cells, resulting in a decreased in the number of frame members such as cross members disposed within the casing. In the structure including a share panel fastened to the lower face of the frame member disposed within the casing, as disclosed in JP 2023-46945 A and WO 2013/073464 described above, the decreased number of frame members leads to an increase in the distance between locations on the frame members to which the share panel is fastened. This allows an impulsive force from the road surface to be transferred to the battery pack, which may damage the battery pack.

The present disclosure is therefore aimed towards reducing damage to the battery pack caused by the impulsive force from the road surface in an electric motor vehicle including the battery pack mounted under the floor.

An electric motor vehicle according to the present disclosure includes a battery pack including a casing containing cells and being mounted under a floor of the vehicle, at least one first external reinforcement attached to an outer face of a bottom plate of the casing, and a share panel disposed under the first external reinforcement and covering the bottom plate of the casing. The first external reinforcement is disposed to overlap with the cells in a top view, and the share panel is attached to a first lower face of the first external reinforcement.

This configuration enables an impulsive force input from the road surface to the share panel to be input to the first external reinforcement, not directly to the bottom plate of the casing. The electric motor vehicle of the present disclosure therefore reduces damage to the casing caused by the impulsive force from the road surface.

In the electric motor vehicle of the present disclosure, the share panel may be detachably attached, with a shock absorber, to the first lower face of the first external reinforcement.

This configuration enables the shock absorber to absorb the impact energy input to the first external reinforcement, thereby reducing damage to the casing caused by the impulsive force from the road surface. The share panel that is detachably attached also facilitates replacement of the share panel.

In the electric motor vehicle of the present disclosure, the shock absorber may be a resin clip that attaches the share panel to the first external reinforcement, and in response to input of an impulsive force to the share panel from below the vehicle, the clip may be configured to absorb the impulsive force, with an upper end of the clip contacting with the bottom plate of the casing and being collapsed.

It is therefore possible to reduce damage to the casing caused by the impulsive force from the road surface with a simple configuration.

In the electric motor vehicle of the present disclosure, the shock absorber may be a resin adhesive tape interposed between the first lower face of the first external reinforcement and an upper face of the share panel.

This configuration enables the adhesive tape to absorb the impact energy input to the first external reinforcement, thereby reducing damage to the casing caused by the impulsive force from the road surface.

In the electric motor vehicle of the present disclosure, the share panel may have a plurality of locations attached to the first external reinforcement.

This configuration increases an impact energy absorption amount of the shock absorber. This configuration further reduces oscillation of the share panel during traveling of the electric motor vehicle.

In the electric motor vehicle of the present disclosure, the casing may include a frame containing the cells, a plurality of frame members each being disposed between the cells contained within the frame and extending along a width of the vehicle, and a plurality of second external reinforcements mounted under the frame members, respectively. The first external reinforcement may be attached to the bottom plate of the casing to extend along the width of the vehicle between two adjacent frame members of the frame members, and the share panel may be fastened, with a bolt, to a second lower face of the second external reinforcement.

The configuration in which the share panel is fastened to the frame member of the casing with the second external reinforcement being interposed between the share panel and the frame member increases the fastening strength of the share panel. This reduces deformation of the share panel caused by the impulsive force from the road surface, thereby preventing transmission of the impulsive force from the road surface to the casing.

In the electric motor vehicle of the present disclosure, the first external reinforcement may be attached to the outer face of the bottom plate to extend between opposite side portions of the casing along the width of the vehicle.

This configuration enables the first external reinforcement to reinforce the bottom plate of the casing over the entire region along the vehicle width.

In the electric motor vehicle of the present disclosure, the electric motor vehicle may further include left and right side frames disposed on left and right side portions, respectively, of the vehicle and extending along a length of the vehicle, and left and right side shock absorbers attached to the left and right side frames, respectively, and extending along the length of the vehicle. The opposite side portions of the casing may be connected with the left and right side shock absorbers, respectively, and the first external reinforcement may connect the left and right side shock absorbers along the width of the vehicle.

This configuration enables the first external reinforcement to receive the impulsive force in a side collision, thereby reducing damage to the battery pack.

In the electric motor vehicle of the present disclosure, the first external reinforcement may be attached to the outer face of the bottom plate in a front portion of the vehicle, and a front portion of the share panel covering the front portion of the bottom plate may be attached to the first lower face of the first external reinforcement.

In this configuration, the first external reinforcement is attached to the front portion of the bottom plate where interference with the road surface is likely to occur whereas the first external reinforcement is not attached to the rear portion of the bottom plate where interference with the road surface is not likely to occur. This configuration enables establishment of both the cost reduction and protection of the bottom plate of the casing.

In the electric motor vehicle of the present disclosure, the share panel may be composed of a plurality of partial share panels separated along a length of the vehicle. The first external reinforcement may be disposed in a region of the bottom plate covered with at least one partial share panel of the plurality of partial share panels disposed in a front portion of the vehicle. The at least one partial share panel disposed in the front portion of the vehicle may be attached to the first lower face of the first external reinforcement.

As described above, the first external reinforcement is disposed in a region of the bottom plate covered with the front partial share panel where interference with the road surface is likely to occur and the front partial share panel is attached to the first lower face of the first external reinforcement while the first external reinforcement is not disposed in the remaining region of the bottom plate. This enables establishment of both cost reduction and protection of the bottom late of the casing.

In the electric motor vehicle of the present disclosure, the at least one first external reinforcement may include a plurality of first external reinforcements, and the share panel may include a protruding portion protruding toward the bottom plate of the casing between the plurality of first external reinforcements and having a tip end adjacent to the bottom plate of the casing.

This configuration enables dispersion of the impulsive force from the road surface to thereby reduce damage to the casing caused by the impulsive force from the road surface.

In the electric motor vehicle of the present disclosure, the first external reinforcement may be a folded plate member having a hat-shape cross section composed of a web, a pair of flanges standing on opposite ends of the web, and a pair of arms extending outward from leading ends of the respective flanges. Each of the arms may be attached to the outer face of the bottom plate of the casing. The first lower face may be a lower face of the web. The share panel may be attached to the lower face of the web, and the web and each of the flanges may form an interior angle of greater than 90 degrees and 165 degrees or less.

This configuration enables the first external reinforcement to deform and absorb the impact energy caused by the impulsive force from the road surface. This can therefore reduce damage to the casing caused by the impulsive force from the road surface.

In the electric motor vehicle of the present disclosure, the share panel may have a plurality of locations attached to the web of the first external reinforcement.

This configuration increases the impact energy absorption amount by the shock absorber, and also reduces oscillation of the share panel during driving of the electric motor vehicle.

In the electric motor vehicle of the present disclosure, the first external reinforcement may be attached to the outer face of the bottom plate in a front portion of the vehicle, and a front portion of the share panel covering the front portion of the bottom plate in the vehicle may be attached to the lower face of the web of the first external reinforcement.

This configuration enables establishment of both cost reduction and protection of the bottom plate of the casing.

The present disclosure reduces damage to a battery pack caused by an impulsive force from the road surface in an electric motor vehicle including the battery pack mounted under the floor.

### BRIEF DESCRIPTION OF DRAWINGS

Embodiments of the present disclosure will be described based on the following figures, wherein:

FIG. 1 is a bottom view of an electric motor vehicle according to an embodiment;

FIG. 2 is an elevation cross sectional view of the electric motor vehicle according to the embodiment, taken from line A-A in FIG. 1;

FIG. 3 is an elevation cross sectional view of the electric motor vehicle according to the embodiment, taken from line B-B in FIG. 1;

FIG. 4 is a detailed view of portion C in FIG. 2;

FIG. 5 is a detailed view of portion D in FIG. 2;

FIG. 6 is a graph indicating a stroke with respect to a pressing load with a change of the interior angle shown in FIG. 4;

FIG. 7 is an explanatory view showing a change of the impact energy absorption amount with a change of the interior angle shown in FIG. 4;

FIG. 8 is an elevation cross sectional view illustrating an attaching portion of a first external reinforcement of an electric motor vehicle according to a further embodiment;

FIG. 9 is an elevation cross sectional view of the electric motor vehicle according to a further embodiment;

FIG. 10 is an elevation cross sectional view of the electric motor vehicle according to a further embodiment;

FIG. 11 is a perspective view illustrating a configuration of a bottom face of the electric motor vehicle according to a further embodiment; and

FIG. 12 is a cross sectional view taken from F-F line in FIG. 11.

### DESCRIPTION OF EMBODIMENTS

An electric motor vehicle 100 according to an embodiment will be described by reference to the drawings. In the drawings, symbols FR, UP, and RH denote frontward, upward, and rightward, respectively, with respect to the electric motor vehicle 100. Directions opposite to FR, UP, and RH denote rearward, downward, and leftward, respectively. In the following description, simple indication of front and rear, left and right, and up and down refers to front and rear in the frontward and backward direction or along the length, left and right in the leftward and rightward direction or along the width, and up and down in the upward and downward direction or along the height, respectively, of the electric motor vehicle 100, unless otherwise specified.

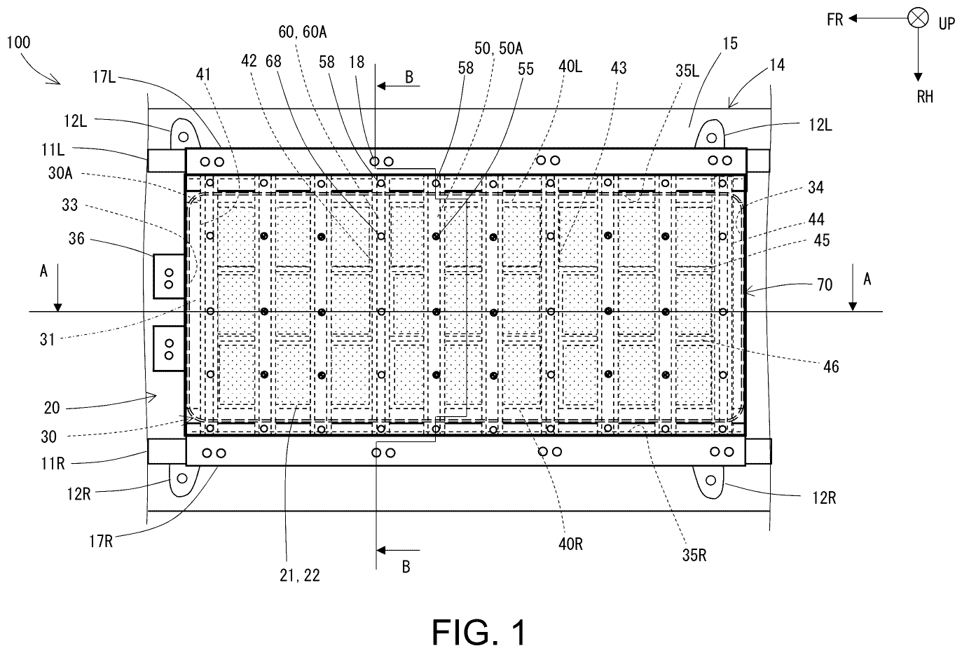

As illustrated in FIG. 1 to FIG. 3, the electric motor vehicle 100 includes left and right side frames 11L and 11R, a cab 14, left and right shock absorbers 17L and 17R, a battery pack 20, a first external reinforcement 50, a second external reinforcement 60, and a share panel 70.

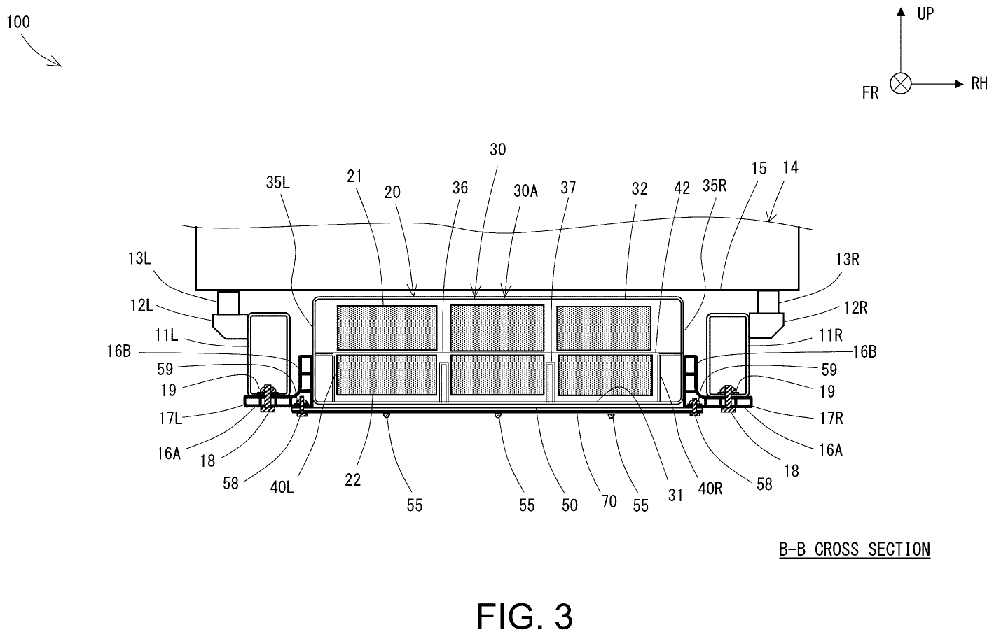

The left and right side frames 11L and 11R are frame members disposed on left and right side portions, respectively, in the center region along the vehicle length and extending along the vehicle length. As illustrated in FIG. 3, the left and right side frames 11L and 11R are elongated member having a closed rectangular cross section. As illustrated in FIG. 1 and FIG. 3, left and right cab mount brackets 12L and 12R are attached on outer faces of the left and right side frames 11L and 11R in the vehicle width direction, respectively. Left and right cab mounts 13L and 13R are further attached on the left and right cab mount brackets 12L and 12R, respectively. The cab 14 is further disposed on the cab mounts 13L and 13R. The cab 14 includes a floor 15 constituting a floor of a vehicle cabin.

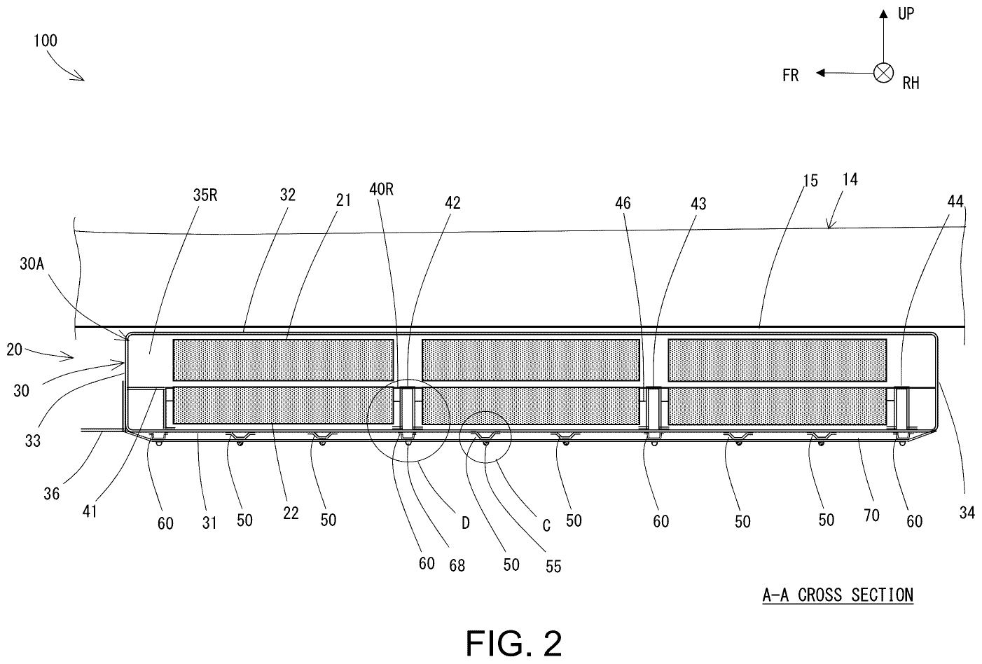

As illustrated in FIG. 2 and FIG. 3, the battery pack 20 is disposed under the floor 15 of the cab 14. The battery pack 20 includes a casing 30 and cells 21 and 22. The casing 30 includes a frame 30A, left and right side rails 40L and 40R, first to fourth cross members 41 to 44, and first and second ribs 45 and 46.

The frame 30A is a member having a substantially rectangular parallelepiped shape and includes a bottom plate 31, a top plate 32, a front plate 33, and a rear plate 34, and left and right side plate 35L and 35R. The left and right side plates 35L and 35R constitute opposite side portions of the casing 30 in the vehicle width direction.

The left and right side rails 40L and 40R are elongated members having an L shape cross section. The left side rail 40L is coupled to the left side plate 35L and the bottom plate 31, and forms, with the side plate 35L and the bottom plate 31, a frame member having a closed cross section extending along the left inner face of the casing 30. Similarly, the right side rail 40R forms, with the side plate 35R and the bottom plate 31, a frame member having a closed cross section extending in the vehicle length direction along the right inner face of the casing 30.

As illustrated in FIG. 2, the first cross member 41, similar to the left and right side rails 40L and 40R, is an elongated member having an L shape cross section, and forms, with the front plate 33 and the bottom plate 31, a frame member having a closed rectangular section extending in the vehicle width direction along the inner face at the front end of the casing 30.

The second to fourth cross members 42 to 44 are frame members having a hat shape cross section and connecting the left and right side rails 40L and 40R in the vehicle width direction. The second to fourth cross members 42 to 44 each have an arm that is connected with the upper face of the bottom plate 31 to thereby form a closed rectangular section structure with the bottom plate 31.

The first and second ribs 45 and 46 are frame members connecting, along the length of the vehicle, two cross members, adjacent to each other in the vehicle length direction, of the first to fourth cross members 41 to 44. The first and second ribs 45 and 46 are members having a hat-shape cross section, and each include an arm that is connected to the upper face of the bottom plate 31 to form, with the bottom plate 31, a closed rectangular cross section structure.

A space between the front plate 33 and the rear plate 34 is divided, in the vehicle length direction, into three regions by the first to fourth cross members 41 to 44. Further, a space between the left and right side rails 40L and 40R is divided, in the vehicle width direction, into three regions by the first and second ribs 45 and 46. As such, a region of the bottom plate 31 of the casing 30 is divided into nine regions by the first to fourth cross members 41 to 44 and the first and second ribs 45 and 46.

The cells 21 and 22 are stacks of storage elements. The cell 22 is disposed in each of the nine regions on the bottom plate 31, and the cell 21 is disposed on each cell 22.

As illustrated in FIG. 3, the left and right shock absorbers 17L and 17R are elongated members having an L shape closed cross section. Each of the left and right side shock absorbers 17L and 17R is composed of a lateral plate portion 16A and a vertical plate portion 16B. The vertical plate portion 16B of each of the left and right side shock absorbers 17L and 17R is connected with an outer face of each of the left and right side plates 35L and 35R of the casing 30. The lateral plate portion 16A of each of the left and right side shock absorbers 17L and 17R is fastened to the lower face of each of the left and right side frames 11L and 11R with a bolt 18 and a nut 19.

As illustrated in FIGS. 1 to 3, the first external reinforcement 50 is an elongated member having a hat shape cross section disposed to extend along the vehicle width. Two first external reinforcements 50 are arranged side by side in the vehicle length direction between the first cross member 41 and the second cross member 42 of the casing 30 so as to overlap the cells 21 and 22 in a top view. Similarly, two first external reinforcements 50 are arranged side by side between the second cross member 42 and the third cross member 43 and between third cross member 43 and the fourth cross member 44 so as to overlap the cells 21 and 22 in a top view. The left and right end portions of the first external reinforcement 50 are fastened, with a bolt 58 and a nut 59, to the lower faces of the lateral plate portions 16A of the left and right side shock absorbers 17L and 17R, respectively, to connect the left and right side shock absorbers 17L and 17R in the vehicle width direction.

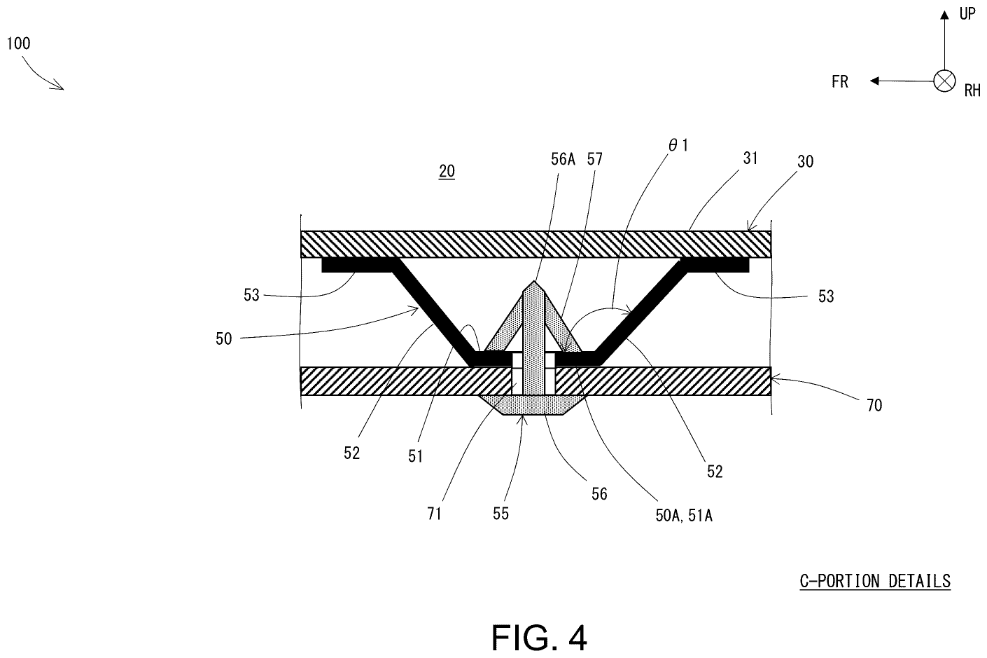

As illustrated in FIG. 4, the first external reinforcement 50 is a folded plate member having a hat cross section that is composed of a web 51, a pair of flanges 52 standing on opposite side edges of the web 51, a pair of arms 53 extending outward from leading edges of the respective flanges 52. The arms 53 are connected with an outer face of the bottom plate 31 of the casing 30. The interior angle θ1 between the web 51 and the flange 52 falls within a range of 90 degrees or greater and 165 degrees or less.

Further, as illustrated in FIGS. 1 to 3, the second external reinforcement 60 is an elongated member having a hat shape cross section extending along the vehicle width. The second external reinforcement 60 is attached under each of the first cross member 41 to the fourth cross member 44 that are frame members extending along the vehicle width. Each of the first to fourth cross members 41 to 44 is disposed between the cells 21 and 22 housed within the casing 30. Therefore, in contrast to the first external reinforcement 50, the second external reinforcement 60 is disposed not to overlap with the cells 21 and 22 in a top view. Similar to the first external reinforcement 50, the second external reinforcement 60 have left and right end portions that are fastened, with the bolt 58 and the nut 59, to the lower faces of the lateral plate portions 16A of the left and right side shock absorbers 17L and 17R, respectively. The second external reinforcement 60, similar to the first external reinforcement 50, connects the left and right side shock absorbers 17L and 17R in the vehicle width direction.

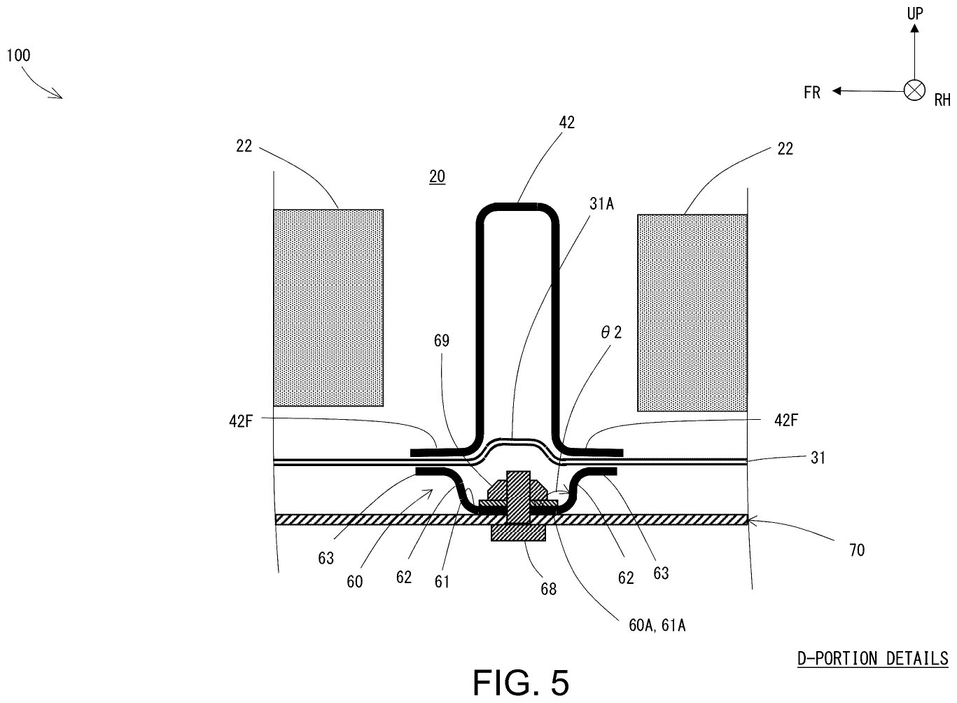

As illustrated in FIG. 5, the second cross member 42 is a member having a hat shape cross section including arms 42F connected with a top face of the bottom plate 31. A portion of the bottom plate 31 between the two arms 42F is a protrusion 31A protruding upward. The second external reinforcement 60 is a folded plate member having a hat shape cross section, composed of a web 61, a pair of flanges 62 rising from opposite side edges of the web 61, and a pair of arms 63 extending outward from the tip ends of the pair of flanges 62, respectively. The web 61 and the flange 62 form an interior angle θ2 of substantially 90 degrees. The arms 63 of the second external reinforcement 60 are connected with the lower face of a portion of the bottom plate 31 where the arms 42F of the second cross member 42 are connected. The third and fourth cross members 43 and 44 have the same structure as that of the second cross member 42.

As illustrated in FIG. 1 to FIG. 3, the share panel 70 is a plate member disposed under the first external reinforcement 50 and the second external reinforcement 60 to cover the bottom plate 31 of the casing 30. The share panel 70 has left and right end portions that are fastened, with the bolt 58 and the nut 59, to the lower faces of the respective lateral plate portions 16A of the left and right side shock absorbers 17L and 17R, along with the first external reinforcement 50 and the second external reinforcement 60. In a region between the left and right side shock absorbers 17L and 17R, the share panel 70 is attached to the lower face 51A of the web 51 of the first external reinforcement 50 and the lower face 61A of the web 61 of the second external reinforcement 60. Here, the lower face 51A of the web 51 constitutes a first lower face 50A of the first external reinforcement 50. Similarly, the lower face 61A of the web 61 constitutes a second lower face 60A of the second external reinforcement 60.

As illustrated in FIG. 1 to FIG. 3, the share panel 70 is attached to a plurality of attachment points on the lower face 51A of the web 51 of the first external reinforcement 50 with clips 55. As illustrated in FIG. 4, the clip 55 that is made of a resin includes a body 56 and an engaging portion 57. The engaging portion 57 extends diagonally downward from an upper end 56A of the body 56, and a lower end of the engaging portion 57 engages with the top face of the web 51. The clip 55 that is removable enables the share panel 70 to be detachably attached to the first lower face 50A of the first external reinforcement 50. Further, as illustrated in FIG. 5, the share panel 70 is detachably attached, with a bolt 68 and a nut 69, to a plurality of attachment points on the lower face 61A of the web 61 of the second external reinforcement 60.

In the electric motor vehicle 100 configured as described above, absorption of the impact energy in response to input of an impulsive force from a road surface below the vehicle to the first lower face 50A of the first external reinforcement 50 will be described.

When an impulsive force is input from the road surface to the first lower face 50A of the first external reinforcement 50, the upper end 56A of the clip 55 comes into contact with the lower face of the bottom plate 31 and is collapsed to thereby absorb the impact energy. This inhibits the bottom plate 31 from being damaged by the impulsive force from the road surface. Thus, the resin clip 55 constitutes a shock absorber.

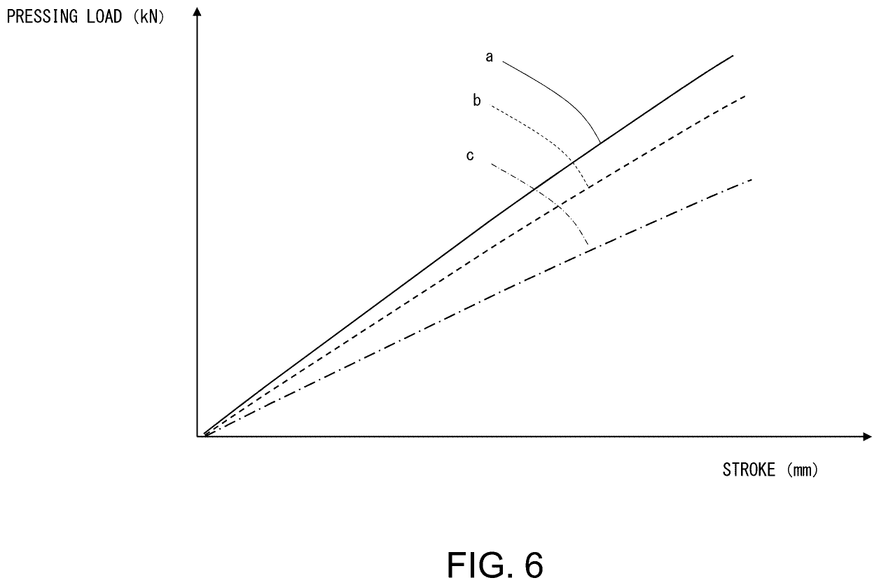

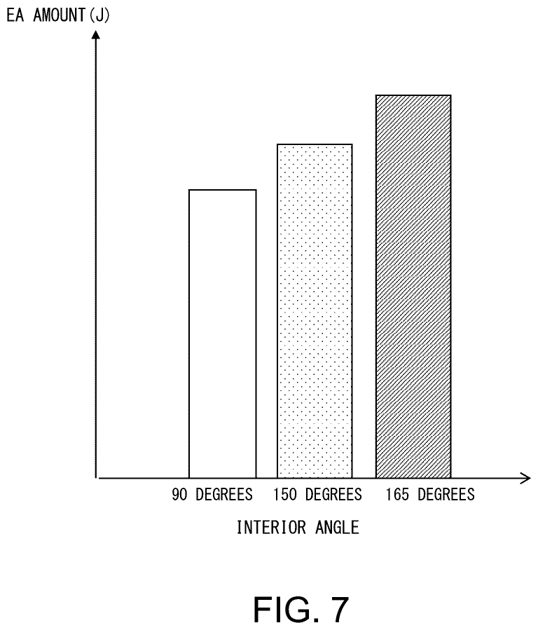

Further, as illustrated in FIG. 4, the interior angle θ1 between the web 51 and the flange 52 of the first external reinforcement 50 is greater than 90 degrees and 165 degrees or less. Therefore, when the impulsive force is input from the road surface to the first lower face 50A of the first external reinforcement 50, the flange 52 deforms to open to thereby absorb the impact energy. FIG. 6 is a graph showing a change amount (stroke) of the height of the first external reinforcement 50 with respect to the pressing load, in response to varying interior angle θ1. In FIG. 6, a solid line a indicates the change amount with the interior angle θ1 of 90 degrees; a broken line b indicates the change amount with the interior angle θ1 of 150 degrees; and an alternate long and short dashed lines c indicates the change amount with the interior angle θ1 of 165 degrees. As shown in FIG. 6, the greater the interior angle θ1, the greater the change amount (stroke) of the height with respect to the pressing load. Therefore, as shown in FIG. 7, the impact energy absorption amount EA of the first external reinforcement 50 in response to the impulsive force input from the road surface to the first lower face 50A of the first external reinforcement 50 increases as the interior angle θ1 increases over 90 degrees.

As described above, in the electric motor vehicle 100, the first external reinforcement 50 is attached to the share panel 70 with the resin clip 55 serving as a shock absorber, and the share panel 70 is further attached to the bottom plate 31 of the casing 30 via the first external reinforcement 50 having a large impact energy absorption amount EA. This configuration reduces damage to the bottom plate 31 caused by the impulsive force input from the road surface to the share panel 70.

While in the above description, the interior angle θ1 between the web 51 and the flange 52 of the first external reinforcement 50 is 90 degrees or greater and 165 degrees or less, the range of the interior angle θ1 may be 150 degrees or greater and 165 degrees or smaller.

In the electric motor vehicle 100, the share panel 70 is attached to the first external reinforcement 50 at a plurality of points. This configuration enables an increase in the impact energy absorption amount EA of the resin clip 55 that is a shock absorber. Also, the share panel 70 is attached to the first external reinforcement 50 and the second external reinforcement 60 at a plurality of points. This configuration reduces oscillation of the share panel 70 during traveling of the electric motor vehicle 100.

Further, in the electric motor vehicle 100, the share panel 70 is fastened, with the bolt 68, to the second lower face 60A of the second external reinforcement 60 connected with the first to fourth cross members 41 to 44 that are frame members. This configuration increases the fixing strength of the share panel 70 to thereby reduce deformation of the share panel 70 caused by the impulsive force from the road surface and thus inhibit transmission of the impulsive force from the road surface to the bottom plate 31 of the casing 30.

Further, in the electric motor vehicle 100, the first external reinforcement 50 is disposed between two adjacent cross members of the first to fourth cross members 41 to 44 that are frame members of the casing 30 in a manner to overlap the cells 21 and 22 in a top view. This configuration increases the strength of portions of the casing 30 where the frame members are not disposed.

Further, in the electric motor vehicle 100, each of the first external reinforcement 50 and the second external reinforcement 60 has opposite end portions connected with the left and right side shock absorbers 17L and 17R, respectively. This configuration of the electric motor vehicle 100 enables the first external reinforcement 50 and the second external reinforcement 60 to receive the impulsive force in a side collision to thereby reduce damage to the casing 30 of the battery pack 20.

The first external reinforcement 50 that is attached to the outer face of the bottom plate 31 and extends between the left and right side plates 35L and 35R of the casing 30 may have the left and right end portions that are not fastened to the left and right side shock absorbers 17L and 17R, respectively. This configuration similarly enables the first external reinforcement 50 to reduce damage to the casing 30 in a side collision.

The battery pack 20 may be at least partially disposed below the floor 15. The electric motor vehicle 100 that is a pickup truck, for example, may have the battery pack 20 including a front portion disposed under the floor 15 and a rear portion disposed under the floor panel of the deck.

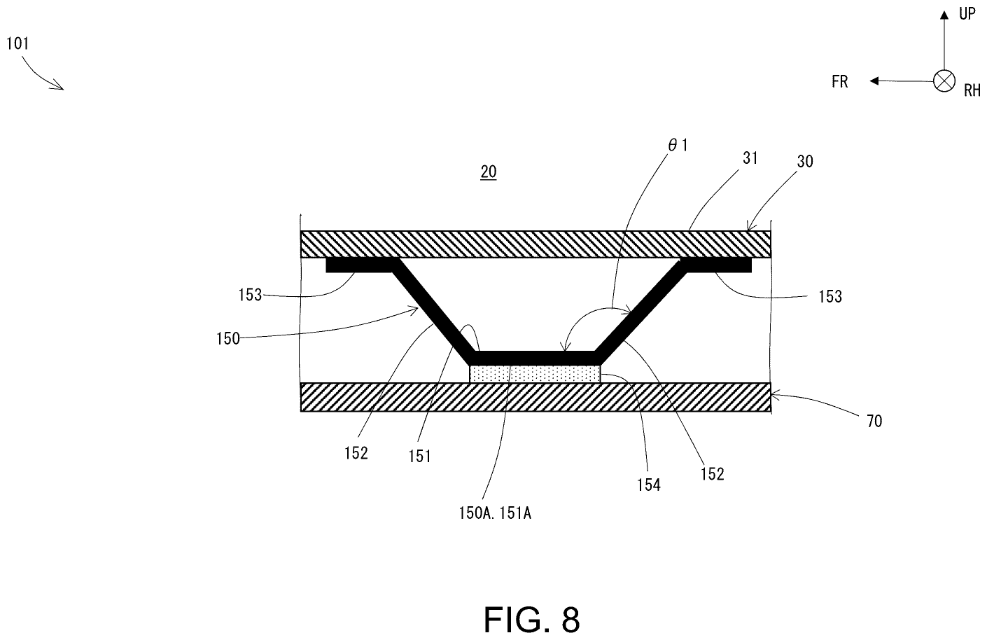

Referring now to FIG. 8, an electric motor vehicle 101 according to a further embodiment will be described. In FIG. 8, elements that are the same as those of the electric motor vehicle 100 described above with reference to FIG. 1 to FIG. 7 are denoted with the same reference numerals and will not be further described.

As illustrated in FIG. 8, the electric motor vehicle 101 includes a first external reinforcement 150 to which the share panel 70 is attached with a resin adhesive tape 154. The first external reinforcement 150, similar to the first external reinforcement 50 of the electric motor vehicle 100 described above with reference to FIG. 1 to FIG. 7, is a folded plate member having a hat-shape cross section composed of a web 151, a pair of flanges 152, and a pair of arms 153. The interior angle θ1 between the web 151 and the flange 152 is greater than 90 degrees and 165 degrees or less. The first external reinforcement 150 has the same configuration as the first external reinforcement 50 except that the web 151 has no hole that allows the clip 55 to pass through.

The resin adhesive tape 154 is interposed between a lower face 151A of the web 151 and the upper face of the share panel 70. The adhesive tape 154 serves as a shock absorber that absorbs impact energy generated when the impulsive force is input from the road surface to the first lower face 150A of the first external reinforcement 150.

As described above, the electric motor vehicle 101 enables the resin adhesive tape 154 to absorb the impact energy input to the first external reinforcement 50 (150?) to thereby reduce damage to the casing 30 caused by the impulsive force from the road surface. The adhesive tape 154 further enables the share panel 70 to be detached from the first external reinforcement 150. Other operation and advantages of the electric motor vehicle 101 are similar to those of the electric motor vehicle 100.

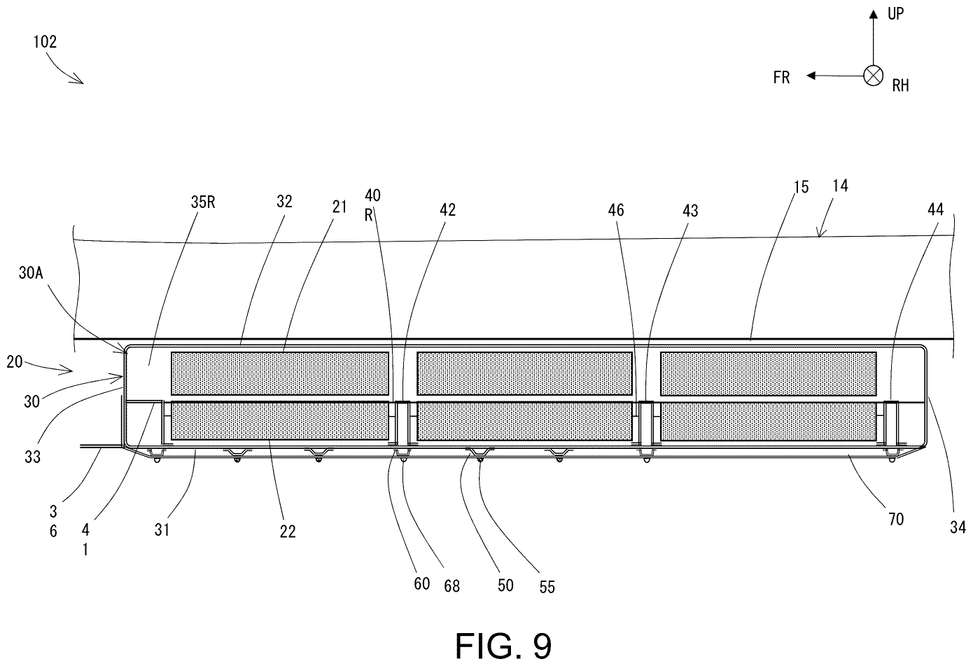

Referring now to FIG. 9, an electric motor vehicle 102 according to a further embodiment will be described. In FIG. 9, elements that are the same as those of the electric motor vehicle 100 described with reference to FIG. 1 to FIG. 7 are denoted with the same reference numerals and will not be further described.

As illustrated in FIG. 9, in the electric motor vehicle 102, the first external reinforcement 50 is attached to the outer face of the bottom plate 31 in a region further forward in the vehicle with respect to the third cross member 43. The front portion of the share panel 70 covering the front portion of the bottom plate 31 located further forward of the vehicle than the third cross member 43 is attached to the first lower face 50A of the first external reinforcement 50, and the first external reinforcement 50 is not disposed in a region further rearward of the vehicle with respect to the third cross member 43.

As described above, the electric motor vehicle 102 includes the first external reinforcement 50 in the front portion of the bottom plate 31 where interference with the road surface is likely to occur, and includes no first external reinforcement 50 in the rear portion of the bottom plate 31 where interference with the road surface is unlikely to occur. This configuration allows establishment of both cost reduction and protection of the bottom plate 31 of the casing 30. Other operation and advantages of the electric motor vehicle 102 are similar to those of the electric motor vehicle 100.

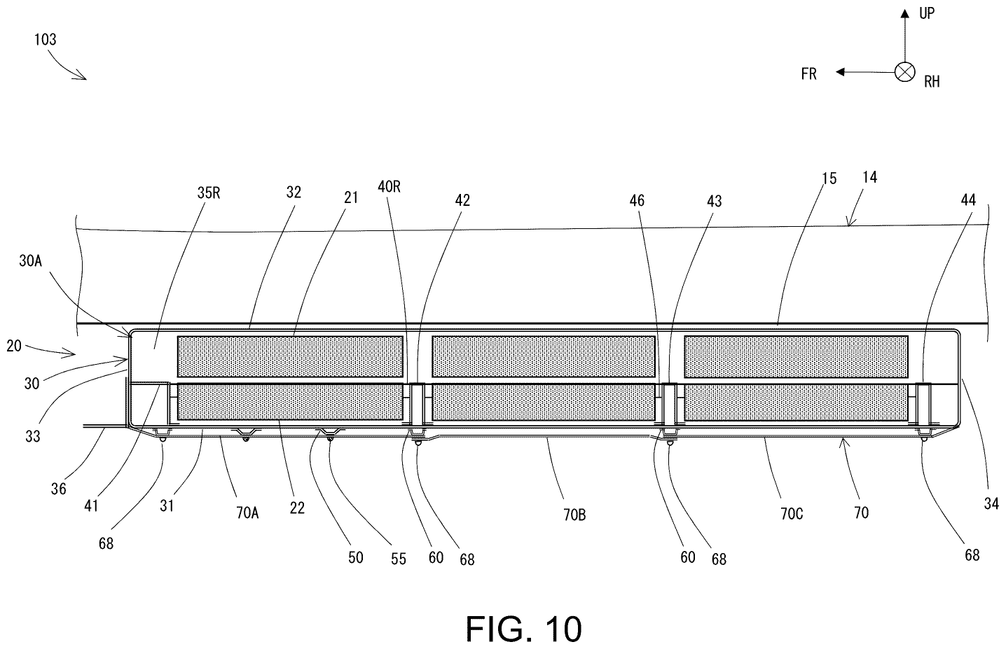

Referring to FIG. 10, an electric motor vehicle 103 according to a further embodiment will be described. In FIG. 10, elements that are the same as those of the electric motor vehicle 102 described with reference to FIG. 9 are denoted with the same reference numerals and will not be further described.

As illustrated in FIG. 10, the share panel 70 of the electric motor vehicle 103 is divided into three portions: a front partial share panel 70A; a center partial share panel 70B; and a rear partial share panel 70C. The front partial share panel 70A covers a region of the bottom plate 31 between the first cross member 41 and the second cross member 42 where the first external reinforcement 50 is disposed. The front edge and the rear edge of the front partial share panel 70A are attached to the second external reinforcement 60 of the first cross member 41 and the second external reinforcement 60 of the second cross member 42, respectively, with the bolts 68. The center portion of the front partial share panel 70A along the length of the vehicle is attached to the first lower face 50A of the first external reinforcement 50 attached to the outer face of the bottom plate 31 with the lip 55.

Meanwhile, the first external reinforcement 50 is not disposed in either a region of the bottom plate 31 covered with the center partial share panel 70B nor a region of the bottom plate 31 covered with the rear partial share panel 70C. Thus, neither the center portion of the center partial share panel 70B along the vehicle length nor the center portion of the rear partial share panel 70C along the vehicle length is attached to the first external reinforcement 50. The front edge and the rear edge of the center partial share panel 70B are attached to the second external reinforcement 60 of the second cross member 42 and the second external reinforcement 60 of the third cross member 43, respectively, with the bolts 68. Similarly, the front edge and the rear edge of the rear partial share panel 70C are attached to the second external reinforcement 60 of the third cross member 43 and the second external reinforcement 60 of the fourth cross member 44, respectively, with the bolts 68.

The rear edge of the front partial share panel 70A and the front edge of the center partial share panel 70B are superimposed and attached together to the second external reinforcement 60 of the second cross member 42 with the bolt 68. The rear edge of the center partial share panel 70B and the front edge of the rear partial share panel 70C are similarly superimposed and attached together to the second external reinforcement 60 of the third cross member 43 with the bolt 68.

As described above, in the electric motor vehicle 103, the first external reinforcement 50 is disposed in a region of the bottom plate 31 covered with the front partial share panel 70A where interference with the road surface is likely to occur, to attach the front partial share panel 70A to the first lower face 50A of the first external reinforcement 50 with the clip 55, whereas the first external reinforcement 50 is not disposed in the remaining region of the bottom plate 31. This configuration enables establishment of both cost reduction and protection of the bottom plate 31 of the casing 30.

While in the above description, the first external reinforcement 50 is disposed in a region of the bottom plate 31 covered with the front partial share panel 70A, whereas the first external reinforcement 50 is not disposed in the remaining region of the bottom plate 31, the present disclosure is not limited to this example. For example, the first external reinforcement 50 may be disposed in a region of the bottom plate 31 covered with the front partial share panel 70A and the center partial share panel 70B, with the region of the bottom plate 31 covered with the rear partial share panel 70C including no first external reinforcement 50. In this configuration, the front partial share panel 70A and the center partial share panel 70B constitute a plurality of partial share panels disposed in the front region of the vehicle.

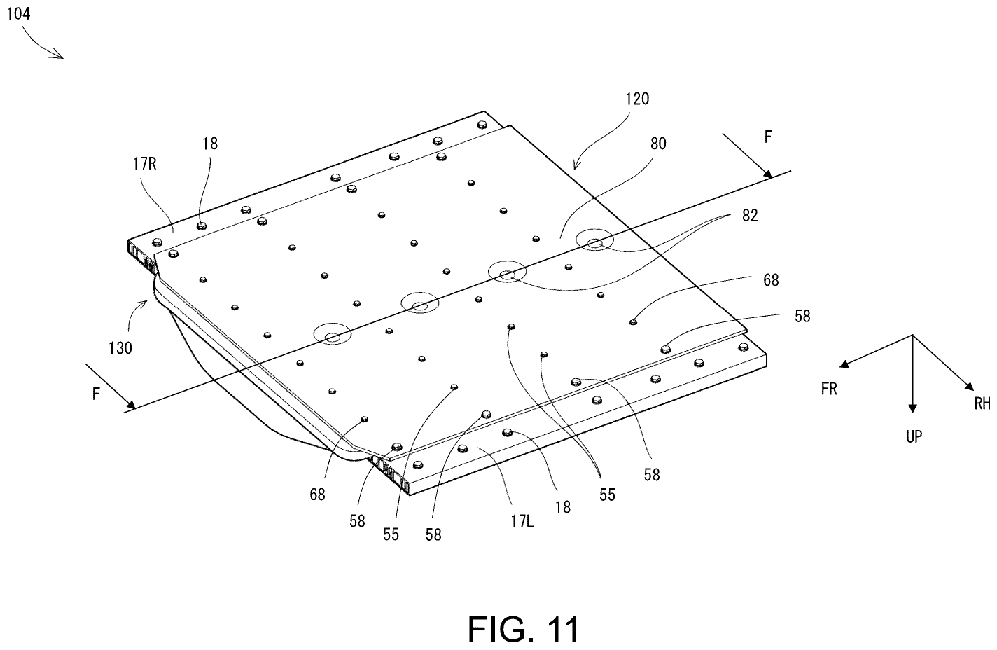

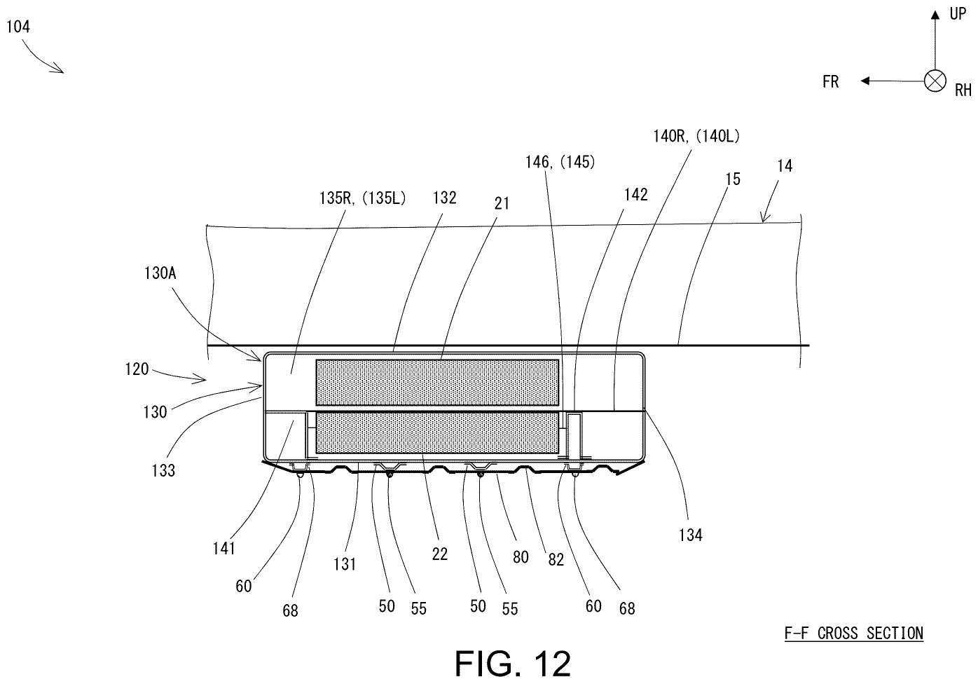

Referring now to FIG. 11 and FIG. 12, an electric motor vehicle 104 according to a further embodiment will be described. In FIGS. 11 and 12, elements that are the same as those in the electric motor vehicle 100 described above with reference to FIG. 1 to FIG. 7 are denoted with the same reference numerals and will not be further described.

As illustrated in FIG. 11 and FIG. 12, the electric motor vehicle 104 includes a battery pack 120 having a casing 130 containing cells 21 and 22. The casing 130 is composed of a frame 130A, left and right side rails 140L and 140R, first and second cross members 141 and 142, and first and second ribs 145 and 146. The frame 130A is a member having a substantially rectangular parallelepiped box shape, and is composed of a bottom plate 131, a top plate 132, a front plate 133, a rear plate 134, and left and right side plates 135L and 135R. The battery pack 120 has a configuration similar to that of the battery pack 20 except that the longitudinal length of the battery pack 120 is shorter than the battery pack 20 described above.

The electric motor vehicle 104 includes a share panel 80 in place of the share panel 70 described above. The share panel 80 includes a protruding portions 82 protruding toward the bottom plate 31 of the casing 30 between the first external reinforcements 50 and having a tip end adjacent to the bottom plate 31 of the casing 30. The protruding potion 82 may have a truncated cone shape as illustrated in FIG. 11.

This configuration of the electric motor vehicle 104 enables dispersion of the impulsive force input from the road surface to the share panel 80 to thereby reduce damage to the casing 30 caused by the impulsive force from the road surface. Other operation and advantages of the electric motor vehicle 104 are the same as those of the electric motor vehicle 100.

As described above, the electric motor vehicles 100, 101, 102, 103, and 104 enable prevention of damage to the casing 30 caused by the impulsive force from the road surface.

1. An electric motor vehicle, comprising:
a battery pack including a casing containing cells, the battery pack being mounted under a floor of the vehicle;
at least one first external reinforcement attached to an outer face of a bottom plate of the casing; and
a share panel disposed under the first external reinforcement, the share panel covering the bottom plate of the casing, wherein
the first external reinforcement is disposed to overlap with the cells in a top view, and
the share panel is attached to a first lower face of the first external reinforcement.

2. The electric motor vehicle according to claim 1, wherein
the share panel is detachably attached to the first lower face of the first external reinforcement with a shock absorber.

3. The electric motor vehicle according to claim 2, wherein
the shock absorber is a resin clip that attaches the share panel to the first external reinforcement, and
in response to input of an impulsive force to the share panel from below the vehicle, the clip is configured to absorb the impulsive force, with an upper end of the clip contacting with the bottom plate of the casing and being collapsed.

4. The electric motor vehicle according to claim 2, wherein
the shock absorber is a resin adhesive tape interposed between the first lower face of the first external reinforcement and an upper face of the share panel.

5. The electric motor vehicle according to claim 1, wherein
the share panel has a plurality of locations attached to the first external reinforcement.

6. The electric motor vehicle according to claim 1, wherein
the casing includes:
a frame containing the cells;
a plurality of frame members each being disposed between the cells contained within the frame, the frame members extending along a width of the vehicle; and
a plurality of second external reinforcements mounted under the frame members, respectively, wherein
the first external reinforcement is attached to the bottom plate of the casing to extend along the width of the vehicle between two adjacent frame members of the frame members, and
the share panel is fastened, with a bolt, to a second lower face of the second external reinforcement.

7. The electric motor vehicle according to claim 1, wherein
the first external reinforcement is attached to the outer face of the bottom plate to extend between opposite side portions of the casing along the width of the vehicle.

8. The electric motor vehicle according to claim 7, comprising:
left and right side frames disposed on left and right side portions, respectively, of the vehicle and extending along a length of the vehicle; and
left and right side shock absorbers attached to the left and right side frames, respectively, and extending along the length of the vehicle, wherein
the opposite side portions of the casing are connected with the left and right side shock absorbers, respectively, and
the first external reinforcement connects the left and right side shock absorbers along the width of the vehicle.

9. The electric motor vehicle according to claim 1, wherein
the first external reinforcement is attached to the outer face of the bottom plate in a front portion of the vehicle,
a front portion of the share panel covering the front portion of the bottom plate is attached to the first lower face of the first external reinforcement.

10. The electric motor vehicle according to claim 1, wherein
the share panel is composed of a plurality of partial share panels separated along a length of the vehicle,
the first external reinforcement is disposed in a region of the bottom plate covered with at least one partial share panel of the plurality of partial share panels disposed in a front portion of the vehicle, and
the at least one partial share panel disposed in the front portion of the vehicle is attached to the first lower face of the first external reinforcement.

11. The electric motor vehicle according to claim 1, wherein
the at least one first external reinforcement comprises a plurality of first external reinforcements, and
the share panel includes a protruding portion protruding toward the bottom plate of the casing between the plurality of first external reinforcements, the protruding portion having a tip end adjacent to the bottom plate of the casing.

12. The electric motor vehicle according to claim 1, wherein
the first external reinforcement is a folded plate member having a hat-shape cross section composed of a web, a pair of flanges standing on opposite ends of the web, and a pair of arms extending outward from leading ends of the respective flanges,
each of the arms is attached to the outer face of the bottom plate of the casing,
the first lower face is a lower face of the web, wherein the share panel is attached to the lower face of the web, and
the web and each of the flanges forms an interior angle of greater than 90 degrees and 165 degrees or less.

13. The electric motor vehicle according to claim 12, wherein the share panel has a plurality of locations attached to the web of the first external reinforcement.

14. The electric motor vehicle according to claim 12, wherein
the casing comprises:
a frame containing the cells;
a plurality of frame members disposed between the cells contained in the frame, the frame members extending along a width of the vehicle; and
a plurality of second external reinforcements attached under the frame members, respectively, wherein
the first external reinforcement is attached to the bottom plate of the casing to extend along the width of the vehicle between two adjacent frame members of the frame members, and
the share panel is fastened to a second lower face of each second external reinforcement with a bolt.

15. The electric motor vehicle according to claim 12, wherein
the first external reinforcement is attached to the outer face of the bottom plate to extend between opposite side portions of the casing along the width of the vehicle.

16. The electric motor vehicle according to claim 15, comprising:
left and right side frames disposed in left and right side portions, respectively, the side frames extending along a length of the vehicle; and
left and right side shock absorbers attached to the left and right side frames, respectively, and extending along the length of the vehicle, wherein
the opposite side portions of the casing are connected with the left and right side shock absorbers, respectively, and
the first external reinforcement connects the left and right side shock absorbers along the width of the vehicle.

17. The electric motor vehicle according to claim 12, wherein
the first external reinforcement is attached to the outer face of the bottom plate in a front portion of the vehicle, and
a front portion of the share panel covering the front portion of the bottom plate is attached to the lower face of the web of the first external reinforcement.

18. The electric motor vehicle according to claim 12, wherein
the share panel is composed of a plurality of partial share panels separated along a length of the vehicle,
the first external reinforcement is disposed in a region of the bottom plate covered with at least one partial share panel of the plurality of partial share panels disposed in a front portion of the vehicle, and
the at least one partial share panel disposed in the front portion of the vehicle is attached to the first lower face of the first external reinforcement.

19. The electric motor vehicle according to claim 12, wherein
the at least one first external reinforcement comprises a plurality of first external reinforcements, and
the share panel includes a protruding portion protruding toward the bottom plate of the casing between the plurality of first external reinforcements, the protruding portion having a tip end adjacent to the bottom plate of the casing.
